(19) United States
(12) Patent Application Publication
(10) Pub. No.: US 2013/0045344 A1
(43) Pub. Date: Feb. 21, 2013

(54) Football Helmet Cover and or Display

(71) Applicant: James Wendell Settles, Flat Rock, NC (US)

(72) Inventor: James Wendell Settles, Flat Rock, NC (US)

(21) Appl. No.: 13/213,043

(22) Filed: Aug. 18, 2011

(51) Int. Cl. B32B 1/00

(52) U.S. Cl. 428/34.1

(57) ABSTRACT

A article of manufacture comprising of, a one piece cover and or display in which is composed of layers of composite materials shaped to resemble a three dimensional football helmet. This article has extruding layers for the facemask display and intruding layers for the ear holes. The football helmet cover and or display is fully enclosed prohibit entry of unwanted items. This football helmet cover can be externally tinted with gel coat prior to manufacture or painted post manufacture. This cover tint to include metallic material to produce a highly reflective exterior topcoat. This cover can be used to reduce the outside elements for such as well heads, water outlets, smaller stumps. This football helmet display can also be used in any decorative faction.

### FIELD OF THE INVENTION

The present invention relates to a composite three dimensional cover/display that resembles a football helmet that is fully enclosed and securable. Invention comprised of composite materials for strength and external protection from the elements as well as decorative effect of the three dimensional football helmet display.

### BACKGROUND OF INVENTION

Three dimensional covers and or displays are used in many applications for covers or ornamental design. This composite substrate offers a fully enclosed football helmet article of manufacture. The football helmet cover/display will offer a versatile application of this invention .

The three dimensional football helmet cover offers options such as covering well pumps, stumps or any area in which a decorative football cover is desired.

The three dimensional football helmet cover offers a display factor a sporting events, pep rally's , school stadium accents, even by the pool or in the flower garden.

The three dimensional football helmet cover offers a fully enclosed face mask and ear hole. These areas are enclosed to create a dome feature on the inside so items covered will be protected from the weather as well as prevent entrance of unwanted items such as bee, bird nests . . .

### SUMMARY OF THE INVENTION

The three dimensional football helmet cover offers a great composite, lightweight and securable display . This versatile cover and or display is one that wants to be seen. The three dimensional football helmet cover can be placed anywhere that a display is desired home, garden, high schools, universities, homecomings, sporting events, pep rally's, fundraisers, sportscasts, news interviews . . .

### DESCRIPTION OF THE DRAWINGS

FIG. 1 Best shows Invention in Front View, 1 represents extruding layers, 2 represents intruding layers and 3 represents securable bracket.

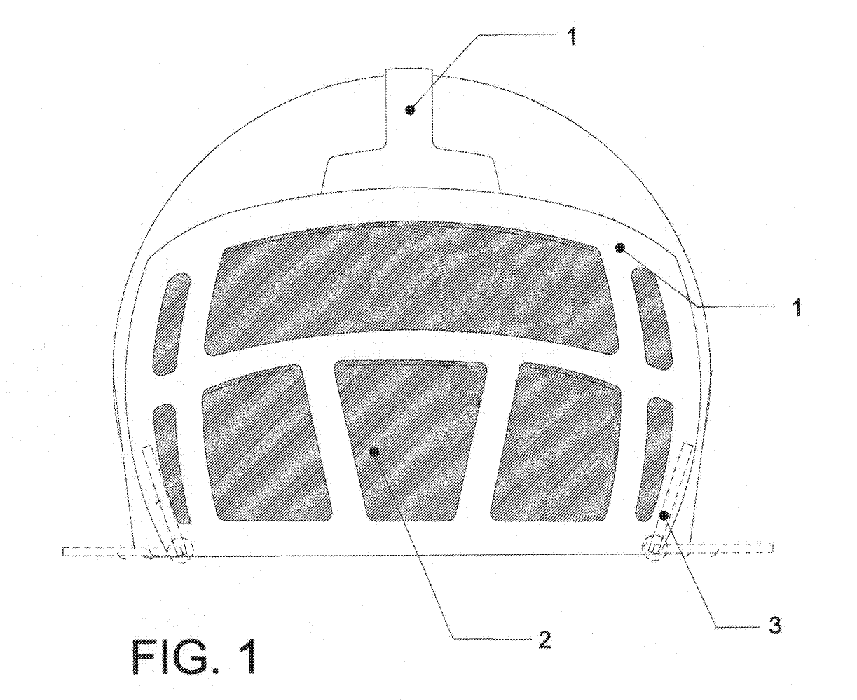

FIG. 2 Best shows Invention in Side View, 1 represents extruding layers, 2 represents intruding layers and 3 represents securable bracket.

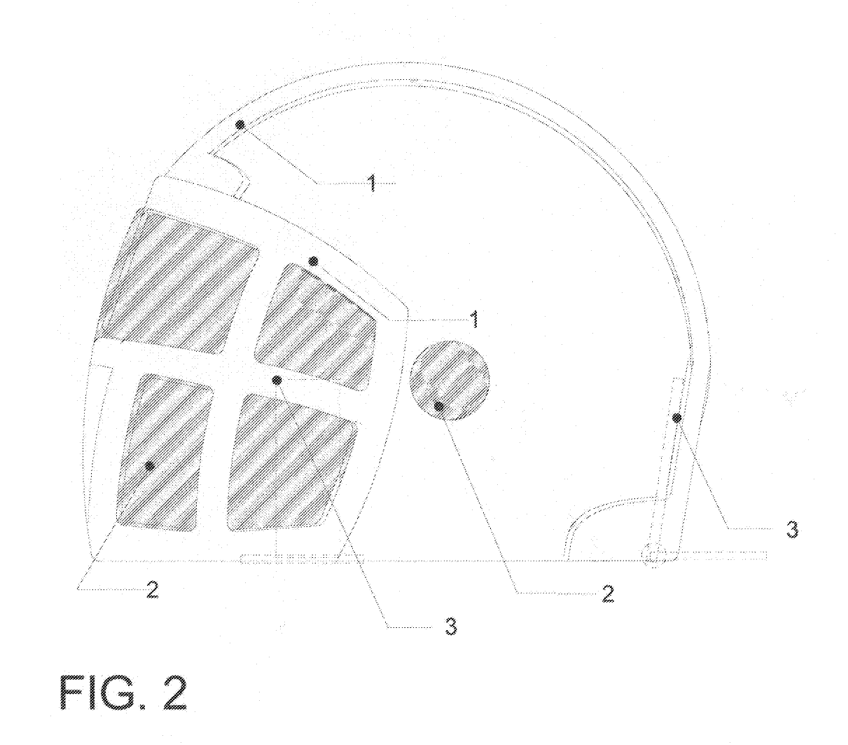

FIG. 3 Best shows Invention in Rear View, 1 represents extruding layers and 3 represents securable bracket.

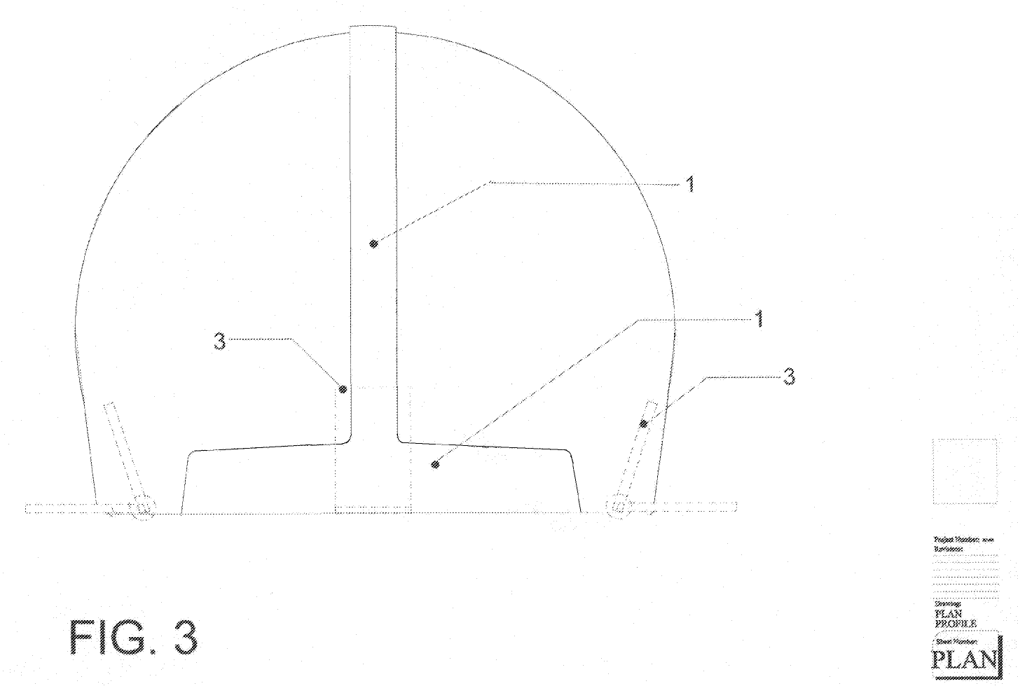

What is claimed is:

1. A cover/display comprising
a) cover resembling a football helmet
b) cover consisting of layers of composite material to form one solid layer of composite material being all one unit with an interior and exterior surface.

2. The cover/display of claim 1. Has a fully enclosed face shield as well as ear hole.

3. The cover/display of claim 2. Has extruding layers of composite material to form the face shield.

4. The cover/display of claim 2. Has intruding layers of composite material to form the ear hole.

5. The cover/display of claim 1. Has an unfinished interior surface for increased strength.

6. The cover/display of claim 5. Has a finished exterior surface for accenting the shape and overall look of the cover/display to resemble a football helmet.

7. The cover/display of claim 6. Has an exterior surface that contains metallic material for a reflective appearance.

8. The cover/display of claim 1. Comprises of multiple anchor points inside the lower rim to eliminate movement.

9. The cover/display of claim 1 (b) Comprises a thickness of between 0.250 inches and 0.500 inches.
